(19) United States
(12) Patent Application Publication
(10) Pub. No.: US 2008/0263872 A1
(43) Pub. Date: Oct. 30, 2008

(54) Scissors and Drives for Scissors

(75) Inventors: Reinhard Ferk, Ludmannsdorf (AT); Manfred Tautscher, Ferlach (AT); Christian Tammegger, Ferlach (AT); Harald Robert, Klagenfurt (AT)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/577,473

(22) PCT Filed: Oct. 10, 2005
(86) PCT No.: PCT/IB2005/053322

§ 371 Date: Jun. 27, 2007

(30) Foreign Application Priority Data
Oct. 18, 2004 (EP) 04105118.6

(51) Int. Cl. B26B 15/00

(52) U.S. Cl. 30/228

(57) ABSTRACT

To allow for starting and/or stopping an automatic scissor drive (6) during the cutting process according to the needs of the user, a push-button (19) is provided on one handle (4b) of a pair of scissors (1). When the cutting blades (3a,b) are closed by the user, such that an angle y is reached, the rubber block (14) pushes the push-button (19), thus starting a drive unit (6). In preferred embodiments, the drive unit (6) includes a motor (9) with an unbalance element (10) inducing vibrations in one of the blades (2a). The blades (2a,b) are coupled by the elastic rubber block (14), such that the scissors (1) act as an oscillating system. The relative movement of the oscillating blades allows to cut automatically.

Conventional scissors normally comprise two blades, whose cutting edges slide past each other for cutting. The blades of generally known scissors are joined by a swivel pin that allows the cutting edges to be opened and closed. For manual handling, the scissors blades usually comprise handles on the side opposite to the cutting edge. One handle is for the thumb and the other handle for one or more other fingers, e.g. the index.

Scissors can be used to cut all sorts of things, such as flat objects like paper, or filamentary objects like hair. The objects to be cut may be quite hard like e.g. wires, twigs or even meat with bones like poultry.

If the objects to be cut are too hard or the user has to cut for long hours without having the possibility to take many breaks, this can cause health problems with the user. Especially shoulders, arms, wrists and fingers are concerned. To palliate for this problem, automatically driven scissors have been developed in the past, fully automated apparatuses without the need for an operator as well as adapted conventional scissors that assist the user.

Adapted conventional scissors for hairdressers are described in the patent U.S. Pat. No. 6,357,121 B1. These scissors include two shanks pivotally connected to each other at a pivot joint, respective blades for cutting the hair extending from the shanks and an electrically powered vibrator for vibrating one of the shanks in a longitudinal direction at an ultrasonic frequency and with a displacement of about 100 to 200 μm. To this effect, the pivot joint of the scissors includes a nail extending from one shank, an eccentric washer embedded in the other shank, which engages around the nail and a miniature motor for rotating the washer and the shank in which it is embedded. When the scissors are closed, the axially oscillating motion component that is additionally superimposed on at least one cutting edge leads to improved cutting properties in that the hair slides between the cutting edges while it is being cut through.

A major drawback of these scissors and others is that the automatic drive is working continuously and no means are provided for starting and/or stopping the automatic drive during the cutting process according to the needs of the user.

It is an object of the invention to provide scissors, that can be operated both manually and automatically and allow for starting and/or stopping the automatic drive during the cutting process according to the needs of the user.

It is a further object of the invention to provide a drive for scissors, especially for scissors, that can be operated both manually and automatically and allow for starting and/or stopping the automatic drive during the cutting process according to the needs of the user.

In a first aspect, the invention provides scissors comprising two blades whose cutting edges slide past each other for cutting, a drive unit exerting a movement on the blades inducing a cutting effect, and a detector unit, said detector unit being capable of detecting a specific relative position of the blades and of starting the drive unit, in case said specific relative position is detected.

The detector unit according to the present invention allows the user to easily switch from manual operation to automatic operation, while cutting. The user only has to position the blades in a certain position and automatic operation starts. This is especially convenient, when the user has to do different kind of cuts in one cutting process, such as cuts with many changes of direction on the one hand that need to be done manually, and long continuous cuts on the other hand that can easily be automatic. By switching into automatic operation whenever possible, the articulations of the user are less strained and the muscles can temporarily relax, without diminishing the cut quality, because complicated cuts are still done manually.

In a second aspect, the invention provides scissors comprising two blades with handles joined by a swivel pin that allows cutting edges of said blades to be opened and closed, a drive unit for temporarily inducing an opening and closing movement of a blade, and a detector unit for detecting a certain angle between the blades and switching on the drive unit, when detecting said angle.

Especially with conventional scissors, like household or hairdressers' scissors, it has been shown to be very convenient to define the specific relative position of the blades as being a certain angle. If the user wants to cut automatically, he closes the scissors to a certain degree, and if he wants to resume manual cutting he opens the scissors again to a certain degree or vice-versa. One prominent advantage is, that the user does not have to learn new cutting techniques, but can handle the scissors according to the present invention like usual conventional scissors.

Preferably, a switch is attached to one of the blades and an activating element is attached to the other blade, whereby the activating element activates the switch, when the blades reach the specific relative position, thus starting the drive unit.

In preferred embodiments of the present invention, a push-button is attached to one of the handles and a protruding element is attached to the other handle, whereby the protruding element pushes the push-button, when the blades reach said angle, thus switching on the drive unit.

Preferably, the drive unit comprises an exciter unit, which is attached to a blade, the blades being coupled by an elastic element, when the drive unit is on, such that the scissors act as an oscillating system.

The exciter unit induces vibration into the blade to which it is attached. But this blade is pivotally joint with the other blade. Thus, the only degree of freedom of movement is a slight up and down movement of this blade. By the elastic coupling, the other blade, too, moves up and down. The scissors are then equivalent to an oscillating system comprising two coupled oscillating masses. The oscillation of the blades leads to an opening and closing movement of the blades where the cutting edges slide past each other for cutting.

Preferably, the drive unit comprises two exciter units, which each are attached to a blade, the blades being coupled by an elastic element, when the drive unit is on, and the exciter units being regulated, such that the blades oscillate in opposite directions. Preferred embodiments of this kind are advantageously used for cutting hard and damping materials.

Preferably, a switch is attached to one of the blades and an activating element is attached to the other blade, whereby the activating element activates the switch, when the blades reach the specific relative position, thus starting the drive unit, and wherein the drive unit comprises an exciter unit, which is attached to a blade, the blades being coupled by an elastic element, when the drive unit is started, such that the scissors act as an oscillating system, whereby the elastic element acts as activating element.

In preferred embodiments, a push-button is attached to one of the handles and a protruding element is attached to the other handle, whereby the protruding element pushes the push-button, when the blades reach said angle, thus switching on the drive unit, and wherein the drive unit comprises an exciter unit, which is attached to a blade, the blades being coupled by an elastic element, when the drive unit is on, such that the scissors act as an oscillating system, whereby the elastic element acts as protruding element.

By using the coupling elastic element as activating or protruding element, it is made sure, that the elastic coupling takes place only when the drive unit is on. This avoids external vibrations to couple into the scissors while manually cutting and disturbing the cutting process. Furthermore, it simplifies the scissors' design and lowers production costs.

In a further aspect, the invention provides a drive unit for scissors having two blades whose cutting edges slide past each other for cutting, for exerting a movement on the blades inducing a cutting effect, comprising an exciter unit, which is attached to a blade, the blades being coupled by an elastic element, when the drive unit is on, such that the scissors act as an oscillating system.

In a last aspect, the invention provides a drive unit for scissors having two blades whose cutting edges slide past each other for cutting, for exerting a movement on the blades inducing a cutting effect, comprising two exciter unit, which each are attached to a blade, the blades being coupled by an elastic element, when the drive unit is on, and the exciter units being regulated, such that the blades oscillate in opposite directions.

These and other aspects of the invention will be apparent from and elucidated with reference to the embodiments described hereinafter.

A preferred embodiment of the present invention is described herein with reference to the drawings wherein:

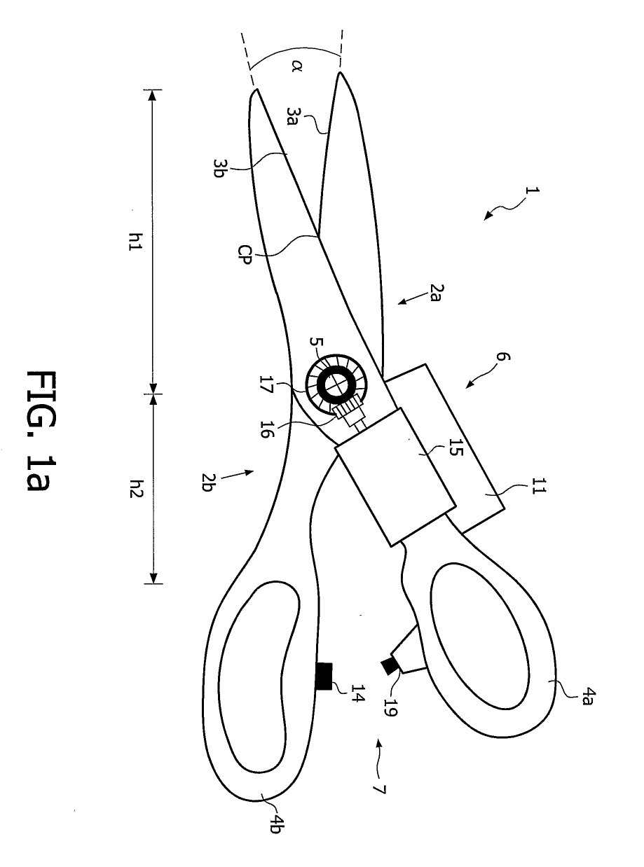

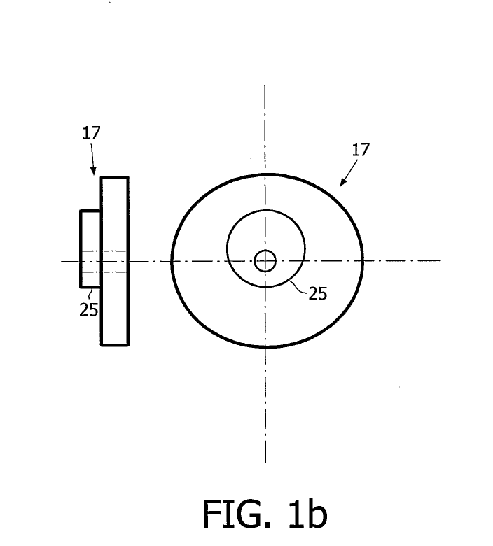

FIG. 1a shows a first embodiment of the invention having a first kind of drive unit and a first kind of detector unit;

FIG. 1b shows an enlarged detail of the first embodiment of FIG. 1;

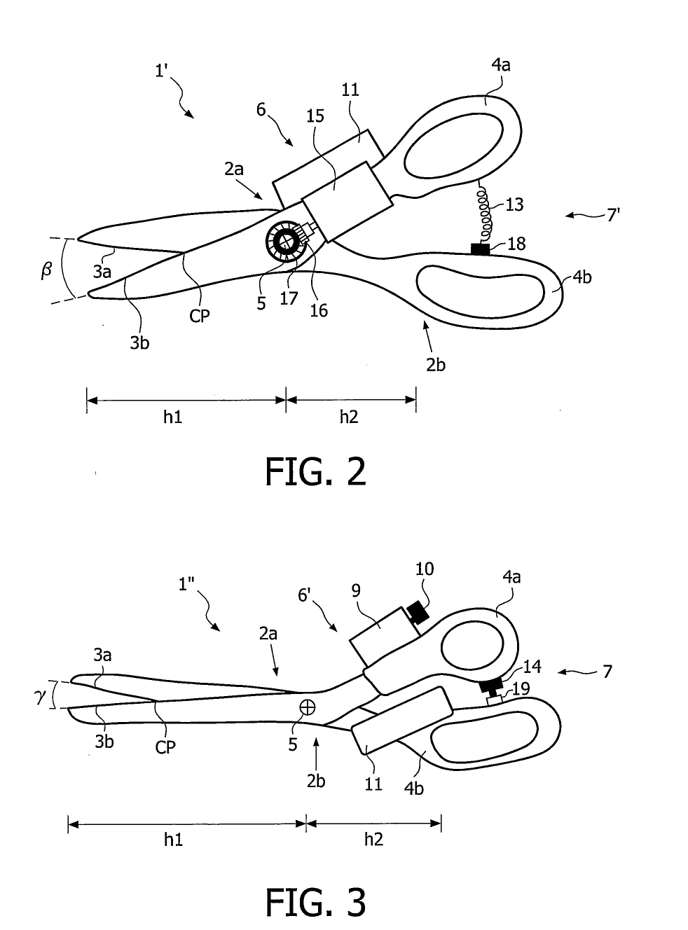

FIG. 2 shows a second embodiment of the invention with a drive unit as in FIG. 1 and having a second kind of detector unit;

FIG. 3 shows a third embodiment of the invention having a drive unit according to the invention with one exciter unit, and a detector unit as in FIG. 2;

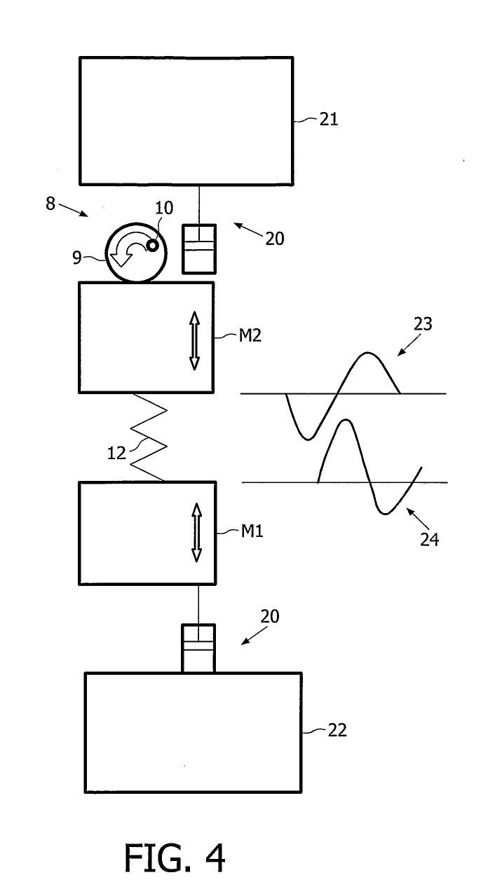

FIG. 4 shows diagrammatically the oscillating system equivalent to the embodiment shown in FIG. 3;

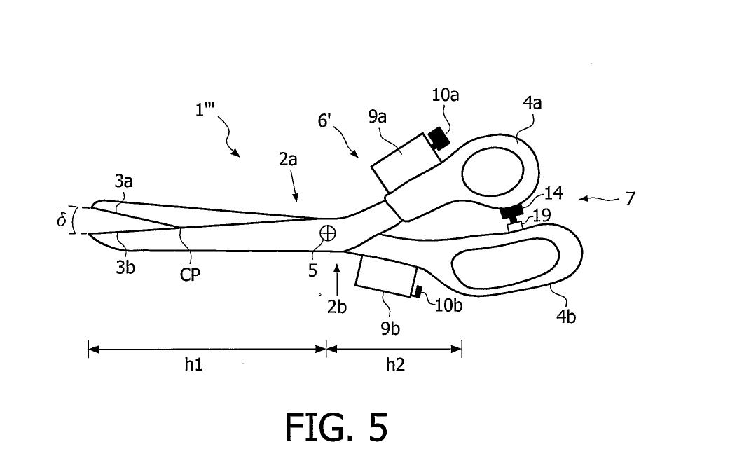

FIG. 5 shows a fourth embodiment of the invention having a drive unit according to the invention with two exciter units, and a detector unit as in FIG. 2 or 3;

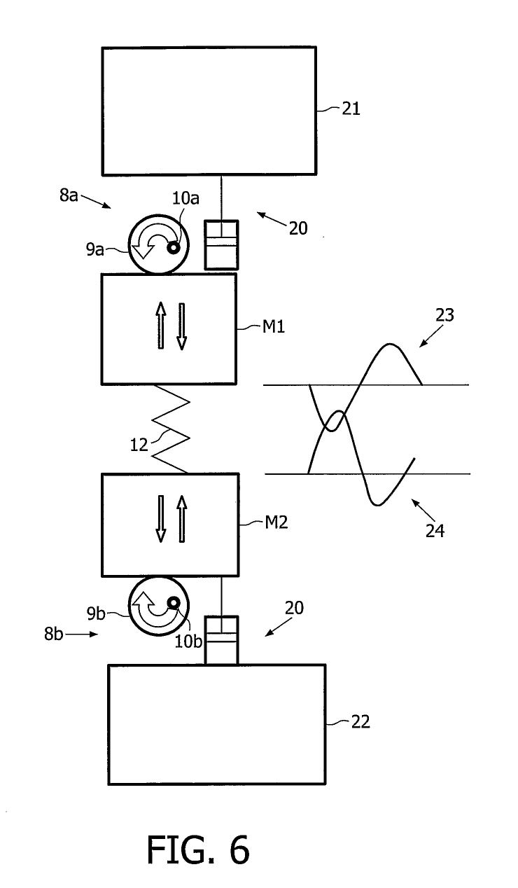

FIG. 6 shows diagrammatically the oscillating system equivalent to the embodiment shown in FIG. 5;

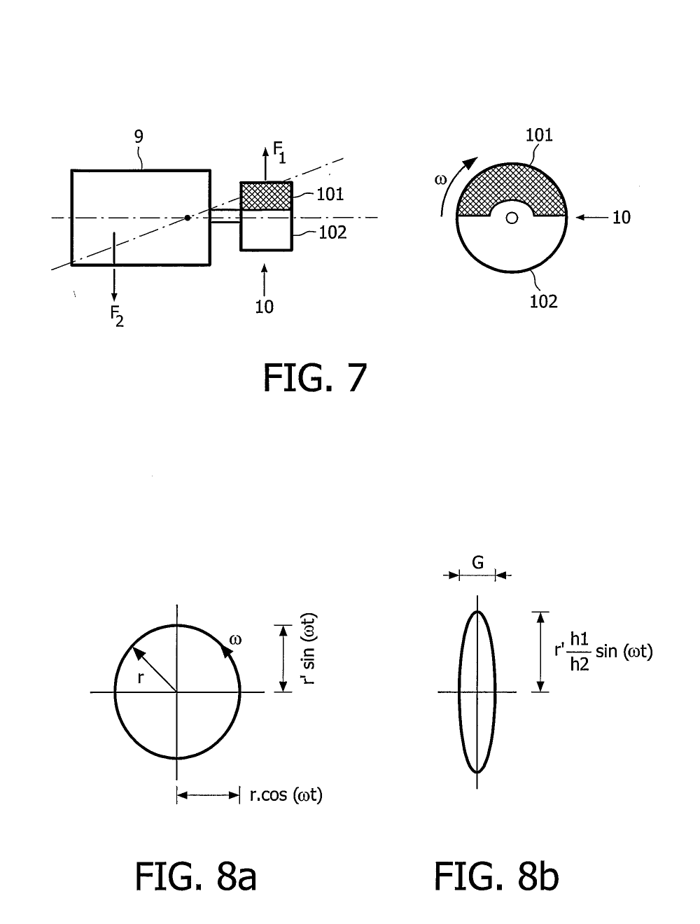

FIG. 7 shows schematically an exciter unit; and

FIGS. 8a,b show diagrammatically the exciting oscillation and the oscillation of the blade.

FIG. 1a shows a first embodiment of the invention having a first kind of drive unit 6, i.e. a mechanical drive, and a first kind of detector unit 7.

The scissors 1 include two blades 2a,b that are pivotally joined by e.g. a swivel pin 5. Each blade 2a,b comprises a handle 4a,b on one side of the pivot join 5 and a cutting edge 3a,b on the other side. Thus the scissors 1 of the example illustrated in FIG. 1a is similar to a conventional pair of scissors like for example household scissors or hair dressers' scissors.

It will be noticed, that the general concept of having a detector unit may as well embodied in any other kind of scissors, such as scissors for gardening or for industrial use etc., and that the scissors need not have exactly two blades, but may have only one blade (see e.g. apparatuses for cutting paper) or more than two blades.

The detector unit 7 of the example shown in FIG. 1a includes a push-button 19 on the lower side of the upper handle 4a for the thumb and a protruding element 14 on the upper side of the lower handle 4b for the other fingers. The push-button 19 and the protruding element 14 are facing each other, such that the protruding element 14 activates the push-button 19, when closing the scissors, i.e. when the angle α between the blades 2a,b is small enough. Activating the push-button 19 switches on the motor 15 of the drive unit 6 (the wiring has been omitted in FIG. 1a for sake of clarity).

In the example illustrated in FIG. 1a, the motor 15 is an electric motor with its own energy supply 11, such as a battery or a reloadable accumulator. It will be noticed, that any other kind of motor could be used, e.g. pneumatic or vacuum driven. The motor 15 rotates a gear 16 cooperating with a second gear 17 around the swivel pin 5 as rotation axis. The swivel pin 5 is fixed to one of the blades, her to blade 2a. the gear 17 has an eccentric washer 25 on the side opposite to the gear 16, as illustrated in FIG. 1b. This eccentric washer 25 is rotatably attached to the other blade, here blade 2b. If the motor 15 is running, the blade 2b moves in the plane of the drawing because of the rotating eccentric washer 25 of the second gear 17.

Depending on the dimensions of the motor 15, the eccentric 16 and the circular gear rack 17, the induced movement of the scissors 1 is an opening and closing that is clearly visible or only possible to be felt as vibration. The dimensions will be chosen in function of the intended use of the scissors. For example, for cutting thin objects like paper or hair, the mere vibration would be enough. The cutting takes place at the cutting point CP, where the cutting edges 3a,b touch, when sliding on one another. The size of the opening and closing needs to be only as large as the thickness of the object to be cut.

For example, if the scissors were to be used for cutting hair, one could dimension the drive unit to have a maximum relative opening between the blades, compared to the opening, when the drive unit is switched on, of ca. 0.3 mm, if one wants to cut the hair with one movement. If one prefers to cut the hair with several movements—the cutting edges “nibbling” through the hair —, one could even reduce this value down to ca. 0.02-0.10 mm. But preferably, one would then choose a higher frequency of the drive unit. Typical frequencies are ca. 200-400 Hz.

One advantage of such “micro-movements” is that, because of the elasticity of the skin, the user will be able to cut hair, but not himself. This makes the scissors quite secure to handle.

It will be noted, that the detector unit 7 not only switches the drive unit 6 on, but switches it off again, if the user opens again the scissors 1 such that the angle α is large enough for the protruding element 14 not to press the push-button 19 anymore. Thus, the handling of the scissors according to the present invention is very convenient for the user. He can use them like conventional scissors or switch to automatic operation by bringing the blades into a specific relative position.

FIG. 2 shows basically the same scissors 1′ as in FIG. 1a, but with a different detector unit 7′. The detector unit 7′ of FIG. 2 comprises a switch 18 and a spring 13 as activating element. The switch 18 is attached on the upper side of the lower handle 4b and the spring 13 connects the switch 18 with the other handle 4a. If the user wants to switch to automatic operation, he just has to open the scissors 1′ wide enough. The spring 13 then pulls on the switch 18 and thus activates the switch 18, which in consequence turns on the motor 15 of the drive unit 6 (the wiring has been omitted for sake of clarity).

In fact, the detector units explained with reference to FIGS. 1a and 2 are only examples for preferred embodiments. The detector units 7,7′ shown in FIGS. 1a and 2 can be slightly modified, like using yearn instead of a spring for the detector unit 7′ of the example shown in FIG. 2, if the user needs only to switch from manual into automatic operation and not back to manual operation. The detector unit of scissors according to the present invention can be based on different basic principles. For example, one could detect the angle α,β between the blades 2a,b or the position of the cutting point CP by means of an electronic caliper or an encoder using optical detection methods, or by using capacitive and/or inductive means. The detector units of the present examples have the advantages to be not only simple and of comparatively low production cost, but also very efficient in that they are quite insensitive to external disturbances and dirt.

FIG. 3 shows a preferred embodiment having the same detector unit 7 as the embodiment illustrated in FIG. 1a, but a different drive unit 6′. The drive unit 6′ according to the present invention includes a motor 9 that rotates an unbalancing element 10 acting as exciter unit.

The exciter unit 8 is shown more in detail in FIG. 7. The unbalancing element 10 is made of portion 101 having a high mass on the one side and a portion 102 having a low mass on the other side. If the unbalancing element 10 rotates with an angle velocity ω driven by the motor 9, a centrifugal force F₁ is acting on the unbalancing element 10. This centrifugal force F₁ is counteracted by the force F₂ acting on the motor 9, leading to an oscillatory movement of the exciter unit 8.

As the motor 9 is fixed to the blade 2a on the handle side, the oscillation of the motor 9 with rotating unbalancing element 10 is transmitted to the blade 2a. But, because the blade 2a is joined pivotally to the other blade 2b, there is only one degree of freedom for the movement of the blade 2a, i.e. opening and closing the scissors 1″. The oscillation of the exciter unit 8 is illustrated in FIG. 8a. This oscillation is transformed in to the oscillatory movement of the blade 2a illustrated in FIG. 8b. Ideally, this movement would be a one-dimensional movement, but in FIG. 8b a clearance gap G of the pivot joint has been taken into account. The amplitude of the movement is weighed with the ration of lever arms h1, h2, i.e. the active length of the blades on both sides of the pivot joint (see FIGS. 1,2,3,5).

This movement is transmitted to the other blade 2b by an elastic element, in the case of the example shown in FIG. 3 by the protruding element 14, which here is a rubber block, coupling the blade 2a and the blade 2b elastically, when the drive unit 6′ is on. In consequence, both blades 2a,b move up and down around the swivel pin 5 that joins them pivotally and open and close the scissors 1″ such that the cutting edges 3a,b slide past each other for cutting. It will be noted, that the drive unit can be modified in that the coupling is independent form the drive being on or off. It will further be noted, that the drive unit 6′ or similar drive units may be used in scissors without detector unit, too.

By way of this coupling, the scissors 1′ act as an oscillating system with two oscillating masses and an excited oscillation. This principle is shown diagrammatically in FIG. 4. The exciter unit 8 is symbolized by the motor 9 with the unbalancing element 10. It is to be noticed that any drive producing some kind of oscillation may be used. The oscillating masses M1 and M2 are equivalent to the masses of the blades 2a,b plus the mass of motor 9 and unbalancing element 10 for M2, respectively plus the mass of the energy supply 11 for M1. The masses M1, M2 are elastically coupled by the elastic element 12, e.g. the rubber block 14 of detector unit 7 or the spring 13 of detector unit 7′. A possibility for the movement 23 of blade 2a and for the movement 24 of blade 2b is illustrated in FIG. 4, too.

It is to be noted, that if one wants to calculate the movements or the parameters like mass, spring constant etc. for specific scissors, one should consider the dampening effect of attenuating elements 20 in form of the thumb 21 and the other fingers 22, that hold the handles during automatic as well as manual operation and are equivalent to fixed masses in the model the oscillating system.

FIG. 5 shows a further preferred embodiment according to the invention, where the drive unit 6′ includes two exciter units with motor 9a and unbalancing element 10a attached to blade 2a and motor 9b and unbalancing element 10b attached to blade 2b. The energy supply and the wiring are omitted for sake of clarity.

Again, the principle of the equivalent oscillating system is diagrammatically illustrated in FIG. 6. In addition to exciter unit 8a with motor 9a and unbalancing element 10a attached to blade 2a, there is exciter unit 8b with motor 9b and unbalancing element 10b attached to blade 2b. Such a drive is efficient in cutting hard and/or dampening material. Preferably, the exciter units 8a,b are regulated such that the masses M1 and M2 oscillate in opposite directions like in a Boxer motor to make the drive unit run more smoothly.

It is noted that the preferred embodiments of the scissors described herein in detail for exemplary purposes are of course subject to many different variations in structure, design, application and methodology. Because many varying and different embodiments may be made within the scope of the inventive concept herein taught, and because many modifications may be made in the embodiment herein detailed, it is to be understood that the details herein are to be interpreted as illustrative and not in a limiting sense. For example, various combinations of the features of the following dependent claims could be made with the features of the independent claim without departing from the scope of the present invention. Furthermore, any reference numerals in the claims shall not be construed as limiting scope.

### LIST OF REFERENCE NUMERALS

scissors
2a,b blade
3a,b cutting edge
4a,b handle
5 swivel pin
6,6′ drive unit
7,7′ detector unit
8,8a,8b exciter unit
9,9a,9b motor
10,10a,10b unbalancing element
101 high mass portion
102 low mass portion
11 energy supply
12 elastic element
13 spring
14 rubber block
15 motor
16 gear
17 second gear
18 switch
19 push-button
20 attenuating element
21 thumb
22 finger
23,24 blade movement
25 eccentric washer
α,β,γ,δ angle
M1,M2 mass
CP cutting point
G clearance gap
h1, h lever arm
F₁, F₂ force
ω angle velocity
r radius

1. Scissors comprising two blades whose cutting edges slide past each other for cutting, a drive unit exerting a movement on the blades inducing a cutting effect, and a detector unit, said detector unit being capable of detecting a specific relative position of the blades and of starting the drive unit, in case said specific relative position is detected.

2. Scissors comprising two blades with handles joined by a swivel pin that allows cutting edges of said blades to be opened and closed, a drive unit for temporarily inducing an opening and closing movement of a blade, and a detector unit for detecting a certain angle between the blades and switching on the drive unit, when detecting said angle.

3. The scissors of claim 1, wherein a switch is attached to one of the blades and an activating element is attached to the other blade, whereby the activating element (14, 13) activates the switch, when the blades reach the specific relative position, thus starting the drive unit.

4. The scissors of claim 2, wherein a push-button is attached to one of the handles and a protruding element is attached to the other handle, whereby the protruding element pushes the push-button, when the blades reach said angle, thus switching on the drive unit.

5. The scissors of claim 1, wherein the drive unit comprises an exciter unit, which is attached to a blade, the blades being coupled by an elastic element, when the drive unit is on, such that the scissors act as an oscillating system.

6. The scissors of claim 1, wherein the drive unit comprises two exciter units, which each are attached to a blade, the blades being coupled by an elastic element, when the drive unit is on, and the exciter units being regulated, such that the blades oscillate in opposite directions.

7. The scissors of claim 1, wherein a switch is attached to one of the blades and an activating element is attached to the other blade, whereby the activating element activates the switch, when the blades reach the specific relative position, thus starting the drive unit and wherein the drive unit comprises an exciter unit, which is attached to a blade, the blades being coupled by an elastic element, when the drive unit is started, such that the scissors act as an oscillating system, whereby the elastic element acts as activating element.

8. The scissors of claim 2, wherein a push-button is attached one of the handles and a protruding element is attached to the other handle, whereby the protruding element pushes the push-button, when the blades reach said angle, thus switching on the drive unit, and wherein the drive unit comprises an exciter unit (8,8a,8b), which is attached to a blade, the blades being coupled by an elastic element, when the drive unit is on, such that the scissors act as an oscillating system, whereby the elastic element acts as protruding element.

9. A drive unit for scissors having two blades whose cutting edges slide past each other for cutting, for exerting a movement on the blades inducing a cutting effect, comprising an exciter unit, which is attached to a blade, the blades being coupled by an elastic element, when the drive unit is on, such that the scissors act as an oscillating system.

10. A drive unit for scissors having two blades whose cutting edges slide past each other for cutting, for exerting a movement on the blades inducing a cutting effect, comprising two exciter unit, which each are attached to a blade, the blades being coupled by and elastic element, when the drive unit is on, and the exciter units being regulated, such that the blades oscillate in opposite directions.
